(19) United States
(12) Patent Application Publication
(10) Pub. No.: US 2025/0138840 A1
(43) Pub. Date: May 1, 2025

(54) TESTING FOR DISTRIBUTED SYSTEMS

(71) Applicant: Salesforce, Inc., San Francisco, CA (US)

(72) Inventors: Benjamin Busjaeger, San Carlos, CA (US); Michael Abebe, Waterloo (CA); Xinan Yan, Waterloo (CA)

(21) Appl. No.: 18/498,822

(22) Filed: Oct. 31, 2023

(51) Int. Cl. G06F 9/448

(52) U.S. Cl. CPC G06F 9/448

(57) ABSTRACT

Techniques are disclosed relating to controlling the ordering of a set of processes executing as part of a distributed computing system on different execution nodes of a computer system. A computer system may track status information relating to execution of the set of processes. The computer system receives a call from a process indicating that the process has reached a code breakpoint. The computer system updates the status information to indicate that the process is in a blocked state and is waiting to be scheduled by the control server. The computer system deterministically selects, from a group of the set of processes that are in the blocked state, a particular process executing on a particular execution node to be executed next in a serial execution order. The computer system responds to a call from the particular process by indicating that the particular process is to unblock and resume execution.

### BACKGROUND

### Technical Field

This disclosure relates generally to computer systems and, more specifically, to various mechanisms for controlling the ordering of processes executing in a distributed system.

### Description of the Related Art

Cloud infrastructure typically includes hardware and software computing resources via which applications can execute that communicate with end users, which may be considered to be tenants of the cloud system. For example, an application may execute in a virtual environment hosted on server-based hardware included in a datacenter of a cloud provider. These applications may be deployed across multiple computing nodes as a distributed system and communicate over a network to implement a service. Because of its complex nature, a distributed system is susceptible to a multitude of physical execution orders, synchronization points, and failure points, which require intensive testing. Tests for debugging the cloud infrastructure or the software deployed by tenants to that cloud infrastructure are created by a developer. As an example, a developer may develop an integration test for testing the interactions between computing nodes. Despite manually written testing, a bug causing a disruption in a distributed system may not be immediately apparent. Moreover, it may be necessary to control the physical execution ordering of node processes to deterministically replicate an error in a distributed system.

### BRIEF DESCRIPTION OF THE DRAWINGS

FIG. 1 is a block diagram of one embodiment of a system having a control server that is capable of controlling the execution path(s) of one or more processes.

FIG. 2A is a block diagram of one embodiment of a system having a control server that is capable of scheduling the execution path(s) of one or more processes and storing information related to the one or more processes.

FIG. 2B is a block diagram illustrating an example of process statuses maintained by the control server.

FIG. 2C is a block diagram illustrating an example of status information maintained by the control server.

FIG. 3A is a block diagram of one embodiment of a control server scheduling a process in a simulation environment.

FIG. 3B is a block diagram of one embodiment of a control server scheduling a parent and child process in a simulation environment.

FIG. 3C is a block diagram of one embodiment of a control server scheduling multiple processes in a simulation environment.

FIG. 4A is a block diagram of one embodiment of a breakpoint database receiving breakpoint records from processes in a production environment.

FIG. 4B is a block diagram of one embodiment of a control server accessing breakpoint records from a breakpoint database to replay the processes.

FIG. 5 is a flow diagram illustrating one embodiment of a method for controlling the ordering of a set of processes executing on different execution nodes.

FIG. 6 is a flow diagram illustrating one embodiment of a method for controlling the ordering of a set of processes executing of different execution nodes in a simulation server.

### DETAILED DESCRIPTION

In many cases, enterprise entities are now shifting from deploying their applications on local infrastructure to deploying them on a cloud infrastructure, such as may be provided by a cloud provider such as Amazon™. Nodes, storage volumes, and other cloud resources are usually provisioned to the cloud infrastructure to enable the deployment and execution of applications. A node, as used herein, is a set of computing resources that can perform some task, independent of some other nodes. For example, two different computer systems may be different nodes. Similarly, two different virtual machines may also constitute different nodes. For example, nodes can be deployed to the cloud infrastructure as a distributed system and communicate with other nodes over a network to facilitate a database service.

In many cases, nodes are communicating over a network and do not share a common (global) clock, with the result that the distributed system is asynchronous. The lack of a global clock makes it difficult to establish an ordering of events in the distributed system. Accordingly, two different executions of the same code on a distributed system can produce different results. The non-deterministic nature of this execution means testing a distributed system is difficult, particularly when reproducing an error during a disruption (e.g., node failure). For example, if a node performs a read request to a second node experiencing replication lag, the node may receive outdated information which may cause further portions of the distributed system to fail. Furthermore, as the infrastructure becomes increasingly distributed with larger customers, more nodes are added to the system, resulting in a system having more complex interactions that are difficult to extensively test.

Conventional approaches for testing a distributed system may be deficient for various reasons. Such approaches include manually writing unit and/or function tests. There are issues with this approach, one of which is that manually writing tests is labor and time intensive. For example, developers will frequently need to spend significant time maintaining and amending their manually written tests as the distributed system is updated or changed with the addition of larger customers. Secondly, developers manually write tests to test interleavings that are considered more error prone. An interleaving refers to a particular sequential ordering of code between two processes; some interleavings might result in different outcomes. For example, a first process may need to read a record while a second process tries to write to the record, and thus the ordering of the two processes may cause the first process to read an outdated record. The large number of possible combinations and interactions between distributed components makes it difficult to account for all possible scenarios. For example, developers may not account for a particular ordering of processes that may disrupt some particular part of the distributed system. Another conventional approach includes manually injecting perturbations (e.g., controlled disruptions) into the system in a stress test environment. A stress test is a performance test that includes standing up a test environment (similar to production) and testing the system under extreme conditions until it fails. For example, a developer may manually kill a node or introduce delays into the system to see if these perturbations will cause a system failure. But when an issue (e.g., node crashed) is discovered, it is often difficult to determine whether the perturbations were the reason for the disruption or whether the perturbations caused an additional issue which ultimately caused the disruption. This disclosure addresses, among other things, how to control the ordering of a set of computer processes in a distributed system, in a manner that may overcome some or all of the above-described deficiencies.

In various embodiments described below, a computer system implements a control server that can manage processes executing on different nodes in a distributed system to achieve a serial ordering. As part of managing one or more processes, the control server schedules the processes based on a scheduling algorithm that utilizes breakpoints. Code breakpoints are designated points manually or automatically injected into the code that cause a process to perform an action that is usable to help recreate an error observed during execution or to yield execution to the control server to preempt processes at critical points to expose data races or other invariant violations.

Within the context of this disclosure, execution may occur within a simulation environment or a production environment. A simulation environment is an environment in which distributed software is being tested to ensure its behavior and performance are as expected. A production environment is one in which distributed software is made available to end-users, and typically refers to the latest version of the software. There can be various levels of production environments, such as beta releases, etc. In general, simulation and production environments will differ in that simulation environments will be executing test programs generated by or on behalf of the software developer, while production environments will be carrying out tasks directed by end-users (and thus not performing a simulation). Additionally, code breakpoints are used for slightly different purposes in each environment.

Code breakpoints are used in a production environment to log the ordering of processes executing on different computing nodes respective execution path. For example, when a process reaches a breakpoint in a production environment, information is created and stored that includes a timestamp describing when the process reached the breakpoint. This information, which may be called a breakpoint record in one embodiment, can be used in the event of an error to recreate an error that was detected—this recreation can be performed in a simulation environment.

Code breakpoints may be used in a simulation environment, on the other hand, to control the ordering of a processes executing in a distributed computing environment. For example, when an executing process reaches a breakpoint in a simulation environment, the process performs a call to a simulation or control server. As a result of this call (which may be referred to as a “blocking call”) the process is blocked and cannot continue to execute until the simulation server schedules and unblocks the process. The simulation server can deterministically select which process to execute next to create a serial execution order. In this manner, if an error is detected, the conditions that led to the error can be recreated.

Breakpoints are thus manually and/or automatically added to the code in various areas where particular code sections (e.g., locks, forks, Input/Output operations, etc.) are interacting externally (e.g., making a call to some other process or resource) in way that can result in a non-deterministic execution ordering. For example, if processes are allowed to fork other processes or threads without the control server gaining control of them, then a program's execution would likely not result in the same output and state if re-executed. Accordingly, breakpoints can be added at certain points in the program's code (e.g., manually or automatically added at a fork function) to permit the control server to gain control. The control server, in various embodiments, keeps track of all active processes that are registered with the control server, including by storing a status and scheduled time associated with the respective process. Based on the stored information, the control server can make a random yet deterministic scheduling decision to serialize all registered distributed processes into a single execution path. After the control server selects the next process, the control server responds to the blocking call of the selected process and the process is unblocked. The process continues to run until it reaches the next breakpoint.

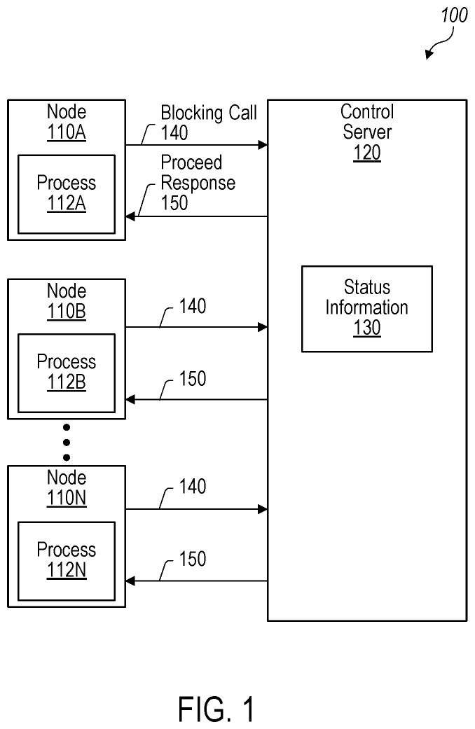

Upon detection of an error for distributed software, the techniques disclosed herein may be used to recreate or replay the conditions that led to the error. When replaying the same execution paths of one or more processes, the control server, in various embodiments, may use a seed associated with the random ordering or the collection of breakpoint records to deterministically order the process in the same way that led to the original error. An exemplary application of these techniques will now be discussed, starting with reference to FIG. 1.

Turning now to FIG. 1, a block diagram of one embodiment of a system 100 is shown. System 100 includes a set of components that may be implemented via hardware or a combination of hardware and software routines. In the illustrated embodiment, system 100 includes control server 120 and nodes 110A-N. As further depicted, nodes 110A-N execute processes 112A-N respectively, and control server 120 includes status information 130. Processes 112 are part of a distributed software product or service in some embodiments.

System 100, in various embodiments, implements a platform service (e.g., a customer relationship management (CRM) platform service) that allows users of that service to develop, run, and manage applications. System 100 may be a multi-tenant system that provides various functionality to users/tenants hosted by the multi-tenant system. Accordingly, system 100 may execute software routines from different users (e.g., providers and tenants of system 100) as well as provide code, web pages, and other data to users, databases, and entities (e.g., a third-party system) that are associated with system 100. In various embodiments, system 100 is implemented using a cloud infrastructure provided by a cloud provider. Thus, nodes 110A-N and control server 120 may execute on and utilize the available cloud resources of the cloud infrastructure (e.g., computing resources, storage resources, network resources, etc.) to facilitate their operations. As an example, control server 120 may execute in a virtual environment hosted on server-based hardware included within a datacenter. But in some embodiments, system 100 is implemented utilizing a local or private infrastructure as opposed to a public cloud.

A node 110, in various embodiments, is a VM that has been deployed onto resources of a cloud infrastructure of a node pool. The resources may include hardware (e.g., CPUs, GPUs, disks, etc.), software routines (e.g., operating systems), or a combination thereof that are provisioned by a cloud provider to the cloud infrastructure. As noted, a node 110 is a physical computing device (e.g., server hardware) on which applications can be deployed or otherwise installed. In various embodiments, the software executing on one node 110A may interact with the software that is executing on another node 110B. For example, a process (e.g., process 112A) executing on node (e.g., node 110A) might communicate with a process (e.g., process 112B) executing on another node (e.g., node 110B) to transfer data from the storage of node 110A to the storage of that other node 110B.

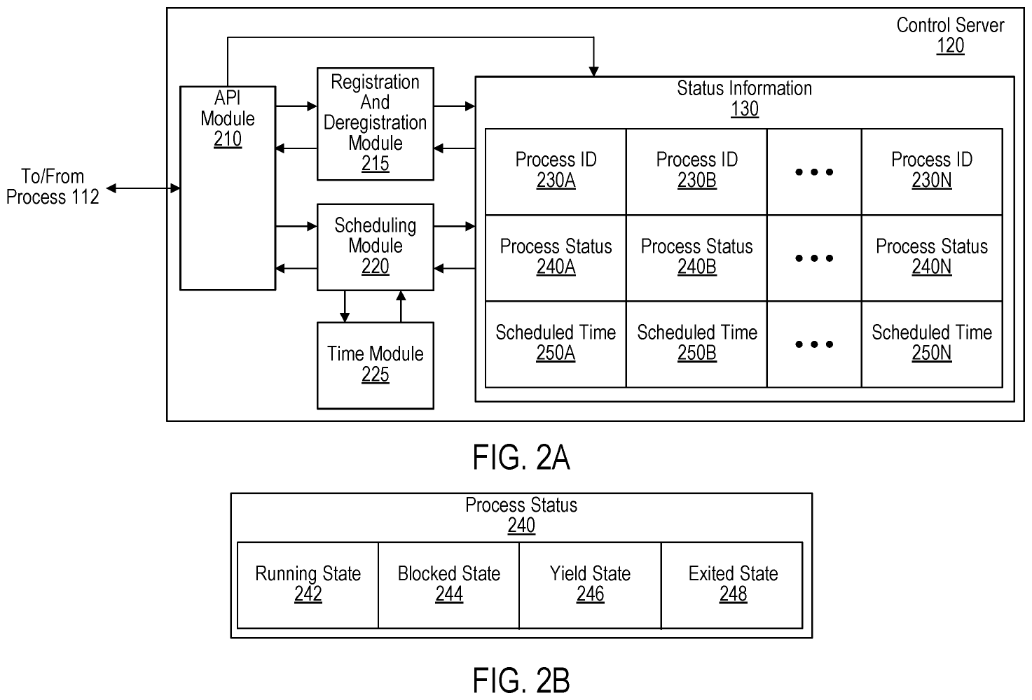

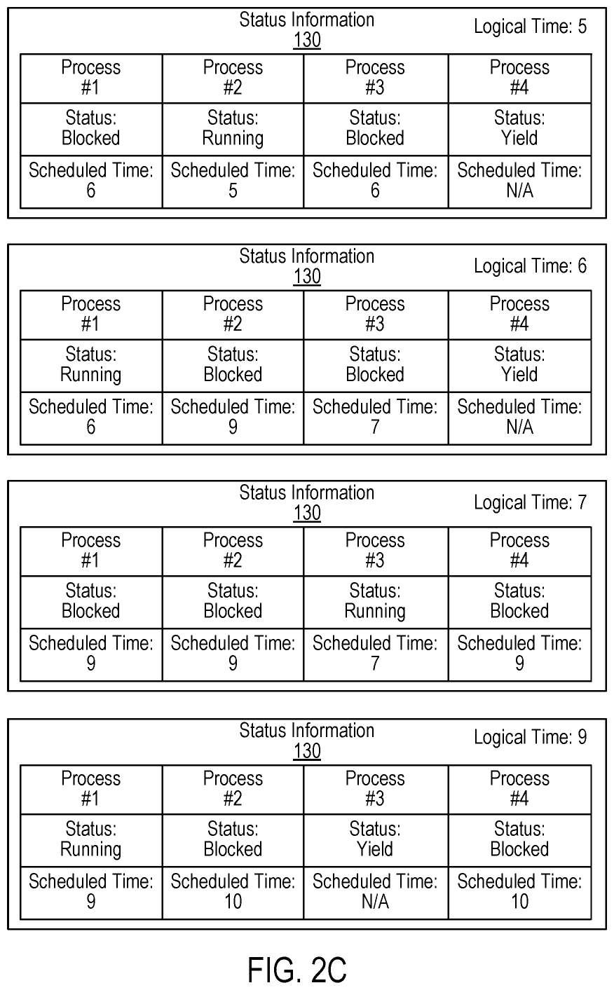

Control server 120, in various embodiments, is a physical device that stores code executable to control the ordering for a one or more processes 112A-N executing on their respective nodes 110A-N according to scheduling techniques such as seeded randomness to ensure the processes 112 execute serially. Control server 120 may be a process that runs separately (e.g., on its own set of nodes) and independently of nodes 110A-N. Control server 120 can deterministically select which process 112 to execute from a list of registered processes 112A-N stored in status information 130. Control server 120 responds to its respective call, causing process 112 to unblock and execute until it reaches a code breakpoint. Control server 120 is discussed in greater detail with respect to FIG. 2.

As previously discussed, a breakpoint is a place within code that causes an executing process to perform some action. For example, in a simulation environment, a breakpoint may cause an executing process to perform a call to control server 120. This call is a “blocking” call (as indicated by reference numeral 140). A blocking call, in various embodiments, is a call to server 120 by a process that will cause server 120 to block the execution of the process until server 120 can subsequently schedule that process and allow it to continue executing. For example, process 112A, when blocked, cannot continue executing until a “proceed” response 150 is received from control server 120. A proceed response 150 by server 120 unblocks process 112, allowing it to resume executing.

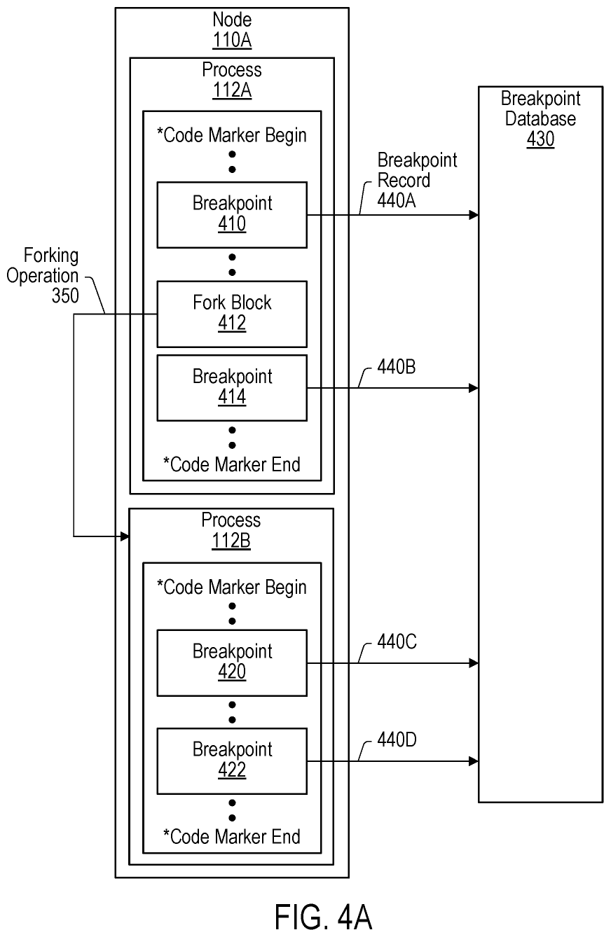

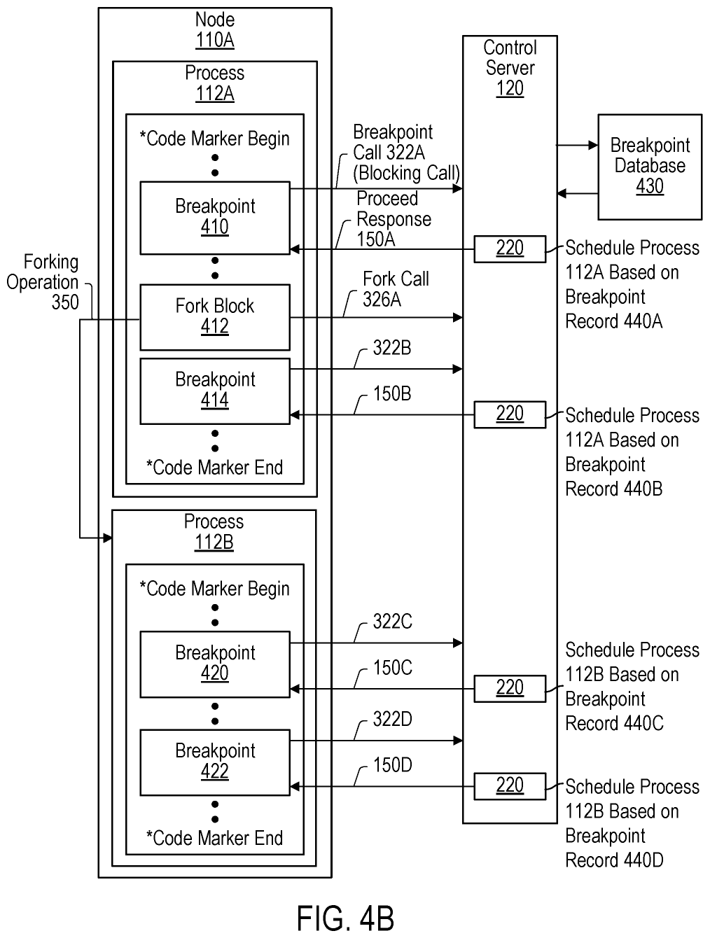

In a production environment, a breakpoint may cause process 112 executing in a production environment to produce a breakpoint record. The breakpoint record may be stored in a storage location (e.g., local memory, database, repository, etc.) accessible to control server 120 along with breakpoint records for other processes in a distributed software product. In the event of an error in the production environment, these breakpoint records may be used in a testing environment to recreate the error for debugging purposes by replaying the order in which processes are executed in a deterministic fashion. Breakpoint records are discussed in greater detail with respect to FIG. 4A.

These techniques may advantageously allow for the deterministic, serial execution of processes 112 when debugging and/or testing a distributed software product. Because control server 120 has the ability to randomly determine the execution ordering of processes 112, this allows control server 120 to create a very rich and diverse set of tests, thereby reducing or eliminating the need for manually developing tests for every potential interaction between components of the distributed system. Accordingly, control server 120 may discover bugs produced by a particular execution path that was not anticipated by developers. This is particularly useful when the system is updated to include larger customers and thus introduces more components (and additional points of failure) to the distributed system. Additionally, developers may use control server 120 to replay the previously executed ordering of processes based on breakpoint records while performing a step-by-step analysis of the production environment. This allows developers to quickly troubleshoot the production environment and minimizes downtime.

Turning now to FIG. 2A, a block diagram of one embodiment of a control server 120 is shown. In the illustrated embodiment, control server 120 includes API module 210, registration and deregistration module 215, scheduling module 220, time module 225, and status information 130 relating to processes in a distributed software product. As further depicted, status information 130 includes process ID 230A-N, process status 240A-N, and scheduled time 250A-N.

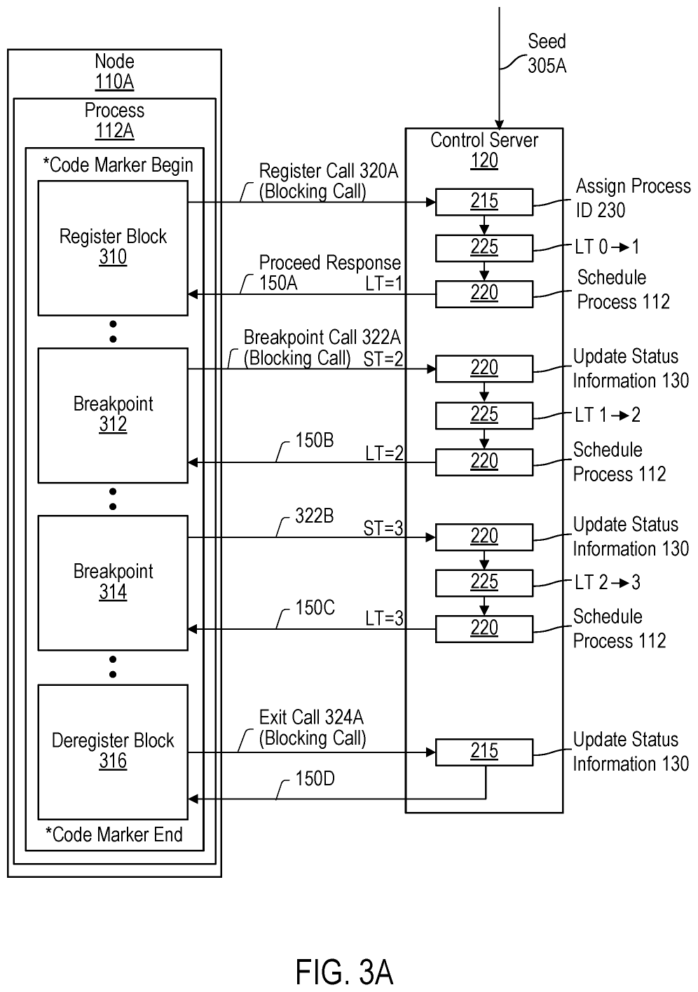

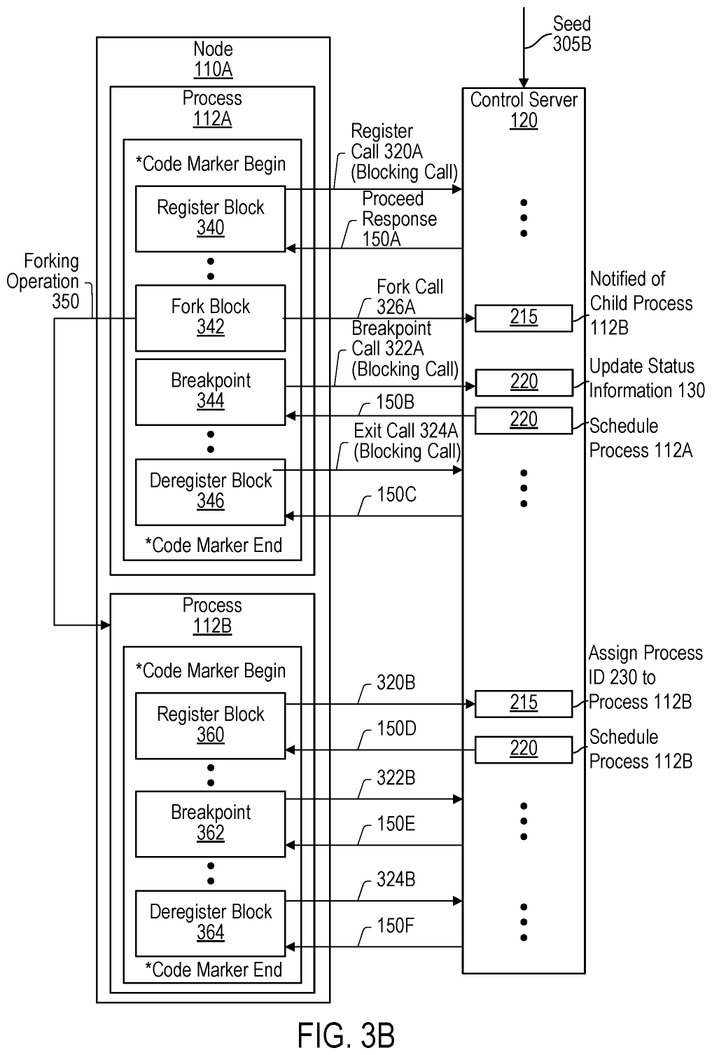

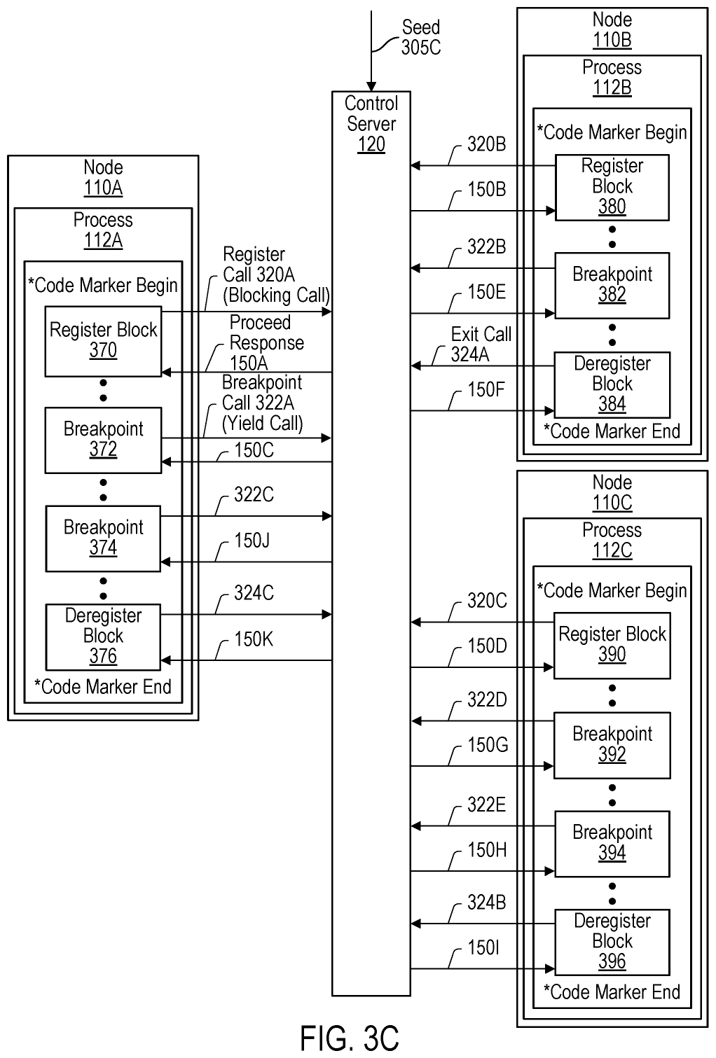

API module 210 is software that implements an application programming interface that facilitates communication between process 112 and control server 120 via blocking calls 140. A blocking call is sent by process 112 to module 210 in order to execute an action based on the type of blocking call. A blocking call 140 can further be classified as a register call, an exit call, a fork call, a breakpoint call, or a yield call. Register and exit calls invoke the registration and deregistration module 215, allowing process 112 to register and deregister to/from control server 120. A fork call is used to inform control server 120 about a forking operation and the creation of a child process. For example, process 112A makes a fork call to control server 120 prior to executing a forking operation to notify server 120 of the upcoming creation of child process 112B. The fork call is discussed in greater detail with respect to FIG. 3B. A breakpoint call is used to inform control server 120 that the executing process has reached a code breakpoint. For example, when an executing process 112B has reached a breakpoint, it makes a breakpoint call in order to inform control server 120 that it has reached a breakpoint and is no longer executing. A breakpoint call is discussed in greater detail with respect to FIG. 3A. A yield call is used to inform control server 120 that the particular process 112 making the call needs to interact with a second process 112 prior to blocking. For example, if process 112A sends a read request to process 112B, it notifies control server 120 and is thus placed in a yield state until process 112B is scheduled and responds. A yield call is discussed in greater detail with respect to FIG. 3C.

Registration and deregistration module 215, in various embodiments, is software that is executable to register or deregister a process 112 to or from a group of simulated processes accessible by scheduling module 220. In order for process 112 to be scheduled by control server 120, it is first registered by module 215 via a register call. Registering process 112 includes assigning a process ID 230, a process status 240, and a scheduled time to process 112, as well as storing its respective information in status information 130. For example, when process 112A first starts up, it performs a blocking call with a register request to control server 120. Module 215 may then assign an ID 230A of process #1, a status 240A of “blocked.” and a schedule time 250A of 2 to process 112A prior to storing its respective information to status information 130. Deregistering process 112 includes removing its respective information from status information 130 via an exit call and thus, removing process 112 from the group of processes registered to control server 120. For example, when process 112A has completed its execution path, it sends an exit request to control server 120 prior to terminating. After receiving the request, module 215 removes process 112A from the list of registered process stored in status information 130, and thus process 112A will not be scheduled by control server 120.

Scheduling module 220, in various embodiments, is software that is executable to perform a scheduling operation in which it schedules the serial execution of processes 112A-N in a deterministic fashion. At a given point in time, various processes may be available to be executed. Thus, scheduling module 220 may decide to schedule the execution of process 112A while a set of other processes remains blocked. Module 220 may employ any of a variety of scheduling techniques, in particular those that produce deterministic (i.e., recreatable) results. Such techniques may include round-robin scheduling, custom scheduling, and seeded randomness. Round-robin scheduling is a scheduling algorithm that manages processes 112 in a cyclic way based on a fixed time. For example, control server 120 may cycle through process 112A-N based on their order of registration to ensure each process 112 is regularly scheduled for execution, and thus control server 120 can deterministically reproduce the ordering based on their respective process ID 230. Custom scheduling, in contrast, is a predefined ordering of processes and is used to test a special execution order. For example, control server 120 may schedule processes 112 based on an ordering defined by a user and thus can deterministically reproduce the ordering when given the same user input. One variant of custom scheduling may be custom-random scheduling in which a developer/user can constrain execution ordering for a subset of processes 112/breakpoints, while allowing the control server to randomly schedule others. This can be useful if developers want to make sure a specific interleaving satisfies invariants. Seeded randomness uses a seed value to schedule a deterministic ordering of processes 112. A seed is an input value that is associated with a particular ordering of the execution paths for processes 112A-N and ensures that the order is reproducible. Thus, when given a particular seed value (e.g., 2), scheduling module 220 randomly schedules the execution paths for processes 112A-N according to some order. When later given the same seed value 2, scheduling module 220 is able to reproduce the same ordering of processes 112A-N. Seeded randomness is discussed in greater detail with respect to FIG. 3.

In some situations, scheduling of processes 112 may also be based on a time value. Time module 225, in various embodiments, is software that is executable to maintain a logical clock based on a logical clock algorithm when executing in a simulation environment. A logical clock, as used herein, is a mechanism used in distributed systems to assign timestamps to processes 112A-N. This clock mechanism is “logical” as opposed to an actual clock in that it does not need to correspond to a real-world clock. This logical clock is used to coordinate the serial ordering of processes 112A-N. Examples of logical clock algorithms include Lamport timestamps and vector clocks. In general, both control server 120 and processes 112 use the concept of a logical time value in order to select processes for execution scheduling. In short, a given process can specify a logical time value at or after which the given process may be scheduled for execution. Control server 120 is executable to schedule only those processes whose scheduled time is at or before the current logical time value. In some embodiments, logical time values may be sequential integers (e.g., 1, 2, 3, etc.).

As previously discussed, status information 130, in various embodiments, is stored information describing processes 112A-N registered to control server 120. Status information 130, in various embodiments, includes a process ID 230A-N, a process status 240A-N, and a scheduled time 250A-N. Control server 120 may store additional information related to processes 112A-N. Process ID 230A-N, in various embodiments, is an identification assigned to processes 112A-N when registering with control server 120. Process ID 230A-N may be a numerical value based on the order at which the process 112 registered with control server 120. For example, process 112B may be assigned a process ID 230B of “2” indicating it was the second process to register with control server 120. In other embodiments, process ID 230A-N may include the identity of the node 110A-N executing the process.

Process status 240A-N, in various embodiments, is the current state of process 112 at a particular logical time. In one embodiment, process status 240A-N may include status information pertaining to a running state, a blocked state, a yield state, and/or an exited state. In other embodiments, process status 240A-N may include additional states for processes 112A-N. Process status 240 is discussed in greater detail with respect to FIG. 2B.

Scheduled time 250, in various embodiments, is the next time value a process is available for scheduling by control server 120. For example, process 112A may have a scheduled time 250 value of 3 and cannot be scheduled until the logical clock is incremented to a value of 3. Control server 120, in various embodiments, selects and schedules a process 112 based on the earliest available scheduled time 250. For example, when control server 120 increments the logical clock to 5, control server may select a process 112A from a list of available process 112 with a scheduled time 250 value of 5. In some embodiments, the default scheduled time 250 for a process 112 is one incremental time value from the current logical time. For example, process 112B may execute at timestamp 2, and when performing a blocking call, process 112B may specify a scheduled time 250 of 3 to control sever 120. Control server 120 may advance time to the next available scheduled time 250 by incrementing the logical time clock by multiple time units to immediately execute the next available process 112. For example, if the current logical time is 3 and the next available process 112A has a scheduled time of 5, control server 120 may increase the logical time to 5 in order to schedule process 112A.

In some embodiments, control server 120 may advance the logical time by an arbitrary value to unblock a particular process 112 regardless of the next available scheduled time 250. For example, if process 112A has a minimum scheduled time 250A of 3 and process 112B has a minimum scheduled time 250B of 5, control server 120 may advance the logical time to 5 in order to schedule process 112B before process 112A. Accordingly, control server 120 may schedule processes 112 in different orders that rarely occur in a production environment and as a result, expose edge conditions. It may be advantageous to advance the time frequently so that time-sensitive background processes 112 that frequently block and time-out get sufficient scheduling time to run.

Turning now to FIG. 2B, a block diagram illustrating different possible values of a process status 240 is shown. In the illustrated embodiment, process status includes a running state 242, a blocked state 244, a yield state 246, and an exited state 248.

A running state 242, in various embodiments, indicates that process 112 is currently executing at the current logical time. For example, scheduling module 220 may select process 112B to execute, and when process 112B is unblocked with a proceed response, the process status 240B for process 112B updates to “running”. A blocked state 244, in various embodiments, indicates that process 112 is currently blocked and waiting to be scheduled by scheduling module 220. For example, the process status 240A for process 112A updates to “blocked” after performing a blocking call to control server 120.

A yield state 246, in various embodiments, indicates that a process 112 has yielded control to control server 120 but has not blocked itself yet as it intends to perform an operation that is dependent on another entity (e.g., one of the processes 112 registered to control server 120). In particular, there are certain cases in which two or more processes 112 need to interact to facilitate an operation (e.g., exchange data), and thus it may be desirable for a process to yield control but not block so that the control sever 120 can initiate the other process 112 needed to complete the operation. For example, process 112A may need to access data using a storage application deployed on different node 110B. Process 112A notifies control server 120 and enters a yield state 246 while it waits for process 112B to exchange data, and thus, control server 120 updates the process status 240B to “yield.” Process 112 yields with the intention of blocking after the operation is completed to prevent the execution of multiple processes simultaneously. For example, when process 112A has completed exchanging data with process 112B, process 112A then enters a blocked state 244.

An exited state 248 indicates that process 112 has completed its execution and is no longer available for scheduling by control server 120. Prior to process 112 being terminated, process 112 sends an exit request to control server 120, and its process status 240 is updated to “exited.” In some embodiments, control server 120 may remove process 112 from the list of registered processes 112. For example, process 112C may perform an exit call prior to terminating, causing control server 120 to remove process 112C from the list of registered processes 112.

Turning now to FIG. 2C, a block diagram of an example of control server 120 scheduling a set of processes #1-4 at particular logical time values is shown. The status information 130 for each process 112 includes a process ID 230, a process status 240, and a scheduled time 250. In the illustration, module 215 has assigned a process ID 230 to each process 112 as processes #1-4 respectively.

In the first illustration, processes #1-4 are currently registered with control server 120, and the current logical time is 5. As shown, process #1 and process #3 have a status of “blocked” with a scheduled time 250 of 6, indicating process #1 and process #3 are available for scheduling at the next logical time of 6. As shown, process #4 has a status of “yield,” and the scheduled time 250 is not available (N/A). Process #4 thus cannot be scheduled by control server 120 until an operation that is dependent on another entity (e.g., one of the processes 112 registered to control server 120) is completed. For example, process #4 may send a request for data to process #3 and will remain in a yield state until process #3 responds with the data. As shown, scheduling module 220 has selected process #2 to execute and has provided a proceed response, meaning that process #2 is unblocked and the status for process #2 is updated to “running.” Process #2 executes for the duration of logical time 5 until it reaches another breakpoint and performs a blocking call. After receiving a blocking call from process #2 with its respective minimum scheduled time 250, scheduling module 220 places process #2 into a blocked state and increments the logical time to the next minimum scheduled time 250 of 6.

As shown, control server 120 will increment the logical clock by one time unit prior to making a scheduling decision and then provide the current logical time value to a particular process 112 when responding to its respective blocking call. Thus, in the second illustration, the current logical time is incremented to 6, and the processes 112 available for scheduling based on a scheduled time of 6 are process #1 and process #3. As further shown, control server 120 has updated status information 130 to reflect that process #2 is now currently in a blocked state with the scheduled time 250 of 9 as provided by process #2. During the scheduling operation, scheduling module 220 selects a process 112 from the group of available processes 112. In this case, module 220 has selected process #1 based on its respective scheduled time 250 of 6 and process ID 230 and provided a proceed response with the current logical time, causing process #1 to unblock and continue executing. The status for process #1 is thus updated to “running”. Since process #3 was not selected, it remains in a blocked state, and its scheduled time 250 is incremented by one logical time unit to 7. As shown, process #4 remains in a yield status as it waits for a response to its request. Process #1 executes for the duration of logical time 6 until it reaches another breakpoint and performs a blocking call. After receiving a blocking call from process #1 with its respective minimum scheduled time 250, scheduling module 220 places process #1 into a blocked state and increments the logical time to the next minimum scheduled time 250 of 7.

In the third illustration, the current logical time is 7, and the only process 112 available for scheduling based on a minimum scheduled time of 7 is process #3. As further shown, control server 120 has updated status information 130 to reflect that process #1 is now currently in a blocked state with the scheduled time 250 of 9 as provided by process #1. Process #2 remains in a blocked state, and its scheduled time 250 remains at 9. Since process #3 is the only available process 112, module 220 has selected and provided a proceed response with the current logical time, causing process #3 to unblock and continue executing. The status for process #3 is thus updated to “running”. In this case, process #4 was waiting on process #3 to fulfill its request, and now that process #3 is executing, it can provide the necessary data to process #3. After receiving a response from process #3, process #4 immediately blocks, and its status 240 and scheduled time 250 are updated to “blocked” and 9, respectively. Process #3 executes for the duration of logical time 7 until it reaches another breakpoint. In this case, process #3 has yielded control to control server 120 but has not blocked itself yet as it intends to perform an operation that is dependent on another process, and thus, server 120 places process #3 into a yield state.

In the fourth illustration, the current logical time is 9. Because the next minimum scheduled time 250 for a process 112 is 9, time module 225 has skipped logical time 8 by advancing the time by 2 units. The processes 112 available for scheduling based on a minimum scheduled time of 9 are process #1, process #2, and process #4. In this case, module 220 has made a scheduling decision and selected process #1 based on its respective scheduled time 250 of 9 and process ID 230. Module 220 provides a proceed response with the current logical time of 9 to process #1, causing it to unblock and continue executing. The status for process #1 is thus updated to “running.” Since process #2 and process #4 were not selected, they remain in a blocked state, and its scheduled time 250 is incremented by one logical time unit to 10. Process #1 executes for the duration of logical time 9 until it reaches another breakpoint. After receiving a blocking call from process #1 with its respective minimum scheduled time 250, scheduling module 220 places process #1 into a blocked state and increments the logical time to the next minimum scheduled time 250 of 10. Because its request has not been fulfilled, process #3 remains in a yield state, and the scheduled time 250 remains as “N/A.” Control server 120 will continue to schedule process #1-4 until all processes 112 have terminated and entered an exited state 248.

Turning now to FIG. 3A, a timing diagram of an example of a scheduling process performed by control server 120 is shown. The scheduling process is performed in a simulation environment. In the illustrated embodiment, control server 120 schedules process 112A. As further illustrated, process 112A includes a register block 310, breakpoint blocks 312 and 314, and a deregister block 316.

As shown, control server 120 receives seed 305A. As previously discussed, seed 305A is an input value associated with a particular execution path for process 112A and ensures that the order is reproducible. For example, control server 120 may first receive a seed value of 1, and the execution path determined by control server 120 is reproducible when reusing the same seed value of 1. In some embodiments, the seed value may be randomly determined, and in other embodiments, the seed value may be selected and provided to control server 120. The seed value may be received by control server 120 after the first process 112A has contacted control server 120.

In the simulation environment, control server 120 may instantiate the required nodes 110A-N that execute processes 112A-N and provide its connection information to each initial process 112A-N. The connection information may be the network address for control server 120. The initial process 112 is referred to as a startup process. The startup process 112 may be the main process that accepts incoming connections and forks off backend processes 112 that service requests via the connection. For example, an application server may receive a request from a user to access records. The application server may communicate with a startup process 112 to establish a database connection. As part of establishing the connection, the startup process 112 may fork a process 112 to handle incoming database requests from the application server. As shown, control server 120 has instantiated node 110A which hosts process 112A. When process 112A starts up, it makes a register call 320A at register block 310 based on the connection information provided by control server 120. Register call 320A is a blocking call that invokes module 215 in order to register process 112A to control server 120. During the registration process, module 215 assigns a process ID 230 to process 112A and stores its respective information in status information 130. For example, process 112A may receive a process ID 230 of process #1. In various embodiments, process 112A may continue to execute when it reaches register block 310 if process 112A is the first and only process registered with control server 120.

Control server 120, in various embodiments, increments the logical clock by one time unit prior to selecting a process to execute from a list of available processes registered to control server 120. For example, time module 225 increments the logical clock from 0 to 1. In this case, process 112A is the only available process registered to control server 120. After selecting process 112A, control server 120 provides a proceed response 150A to process 112A, causing it to unblock. The proceed response 150A may include the current logical time determined by time module 225. For example, control server 120 provides the updated time of 1 to process 112A. After unblocking, process 112A continues to execute until it reaches breakpoint 312. As shown, process 112A reaches breakpoint 312 and performs a breakpoint call with its respective scheduled time 250 to control server 120. For example, process 112A may provide a scheduled time 250A of 2. Process 112A cedes control to control server 120 and is blocked from executing until it receives a proceed response 150. Control server 120 updates process status 240 to “blocked”, indicating that process 112A is no longer executing and is waiting to be scheduled. Again, control server 120 increments the logical clock by one time unit and makes a deterministic scheduling decision, using scheduling module 220, to select an available process (e.g., process 112A). As previously described, control server 120 provides a proceed response 150B with the current logical time to process 112A, and process 112A is unblocked. Control server 120 updates the process status 240 for process 112A to “running”.

After unblocking, process 112A continues to execute until it reaches breakpoint 314. As previously described, process 112A makes a breakpoint call 322B to control server 120 and is again blocked from executing. Control server 120 updates all status information 130 related to process 112A and increments the logical clock by one time unit, using time module 225. Once again, control server 120 makes a scheduling decision to run process 112A and responds to process 112A with a proceed response 150C and the current logical time. Process 112A unblocks and continues to execute until it reaches deregister block 316 and performs an exit call 324A. An exit call 324 is a blocking call that invokes module 215 in order to deregister process 112A from control server 120 and update its process status 240 to “exited”. As previously discussed, an exited state indicates that process 112A has completed its execution and is no longer available for scheduling by control server 120. In some embodiments, process 112A may wait for a proceed response 150D before terminating, and in other embodiments, process 112A may terminate immediately after notifying control server 120.

Turning now to FIG. 3B, a block diagram of a scheduling process example performed by control server 120 is shown. In the illustrated embodiment, control server 120 schedules a parent process (e.g., process 112A) and a child process (e.g., process 112B). As further illustrated, process 112A includes a register block 340, a fork block 342, a breakpoint block 344, and a deregister block 346. As further illustrated, process 112B includes a register block 360, a breakpoint block 362, and a deregister block 364. To simply FIG. 3B, three dots are shown to represent various modules (e.g., registration and deregistration module 215, scheduling module 220, and time module 225) that implement functions during the scheduling process. In some embodiments, the scheduling process is implemented differently than shown. For example, process 112A may not receive a proceed response 105A at register block 340.

As shown, process 112A is instantiated, and control server 120 receives seed 305B. When process 112A starts up, it performs a register call 320A at register block 340, causing registration and deregistration module 215 to register process 112A to status information 130. For example, module 215 may assign a process ID 230A of process #1, a process status 240A of “blocked”, and a scheduled time 250 of 2 prior to storing its information in status information 130. Prior to selecting an available process 112 for scheduling, time module 225 advances the logical clock to the next minimum scheduled time 250A. For example, because process 112A has a scheduled time 250A of 2, time module 225 advances the logical clock to 2. As shown, control server 120 responds to process 112A with proceed response 150A, causing it to unblock, and accordingly, control server 120 updates process status 240A to “running”. Process 112A continues to execute until it reaches fork block 342.

Fork block 342 refers to a forking operation 350 wherein a process (e.g., process 112A) creates a copy of itself, resulting in a child process (e.g., process 112B). Prior to forking, process 112A notifies control server 120 of the upcoming child process' connection via a fork call 326A. As shown, process 112A forks and creates process 112B. Process 112B performs a register call 320B at register block 360, causing module 215 to register process 112B to status information 130. For example, control server 120 may assign a process ID 230B of process #2, a process status 240B of “blocked”, and a scheduled time 250 of 3. After the fork is complete, both parent process 112A and child process 112B cede control to control server 120. Again, control server 120 increments the logical clock and makes a scheduling decision by selecting one of the processes 112 from a list of available processes 112 stored in status information 130. For example, control server 120 may select process 112A based on its scheduled time 250A. As shown, control server 120 responds to process 112A with proceed response 150B, causing it to unblock while process 112B remains in a blocked state. Control server 120 continues to deterministically schedule process 112A and process 112B in a serial order, including updating their respective status information 130, until processes 112A and 112B have terminated via exit call 324A and 324B at deregister block 346 and 364, respectively.

Turning now to FIG. 3C, a block diagram for an example of a scheduling process performed by control server 120 is shown. In the illustrated embodiment, control server 120 schedules processes 112A-C. As further illustrated, process 112A includes a register block 370, breakpoints 372 and 374, and a deregister block 376. Process 112B includes a register block 380, a breakpoint 382, and a deregister block 384, and process 112C includes a register block 390, breakpoints 392 and 394, and a deregister block 396.

In a manner similar to that discussed with respect to FIGS. 3A and 3B, control server 120 receives seed 305C. For example, control server 120 may be given a random seed value of 2 causing control server 120 to randomly schedule (e.g., seeded randomness) the execution paths of processes 112A-C based on the seed value. After receiving the seed value, control server 120 instantiates process 112A. In other embodiments, process 112A may be created by a forking operation performed by a startup process 112. When process 112A starts up, it performs a register call 320A at register block 370, causing control server 120 to register process 112A with its respective status information 130. After incrementing the logical clock to the next minimum scheduled time 250, control server 120 deterministically selects process 112A to execute based on its schedule time 250A. Accordingly, control server 120 provides proceed response 150A with the current logical time to process 112A, causing it to unblock and execute until it reaches breakpoint 372.

In some embodiments, process 112A may need to perform an operation that is dependent on another process 112. For example, process 112A may need to exchange data with process 112B via a network call in order to facilitate its operation. To facilitate the exchange of data, process 112A may issue a particular type of breakpoint call, referred to as a yield call, in which it indicates that it will block after performing the exchange. When process 112A performs a breakpoint call 322A (a yield call) at breakpoint 372, it may provide information regarding the other process 112, which may include its location, to control server 120. Process 112A is placed in a yield state and cannot be scheduled until it receives a response to its network call. For example, process 112A may issue a request to process 112B, and process 112A cannot be scheduled until process 112B responds to its request. Accordingly, control server 120 updates its process status 240A to “yield” and the scheduled time 250A to “not available”. In some embodiments, the yielding process 112 may enter a blocked state after a predetermined amount of time if the request is not fulfilled and may attempt to resend the request when scheduled by control server 120.

Control server 120, in various embodiments, instantiates process 112B based on the information received from process 112A. In other embodiments, all processes 112 in the simulation environment may be instantiated at the start of the scheduling process. Similar to process 112A, process 112B performs a register call 320B at register block 380, and its status information 130 is registered to control sever 120. After incrementing the logical clock to the next minimum scheduled time 250, control server 120 makes a scheduling decision and selects one of the available processes 112 indicated by status information 130. For example, control server 120 cannot select process 112A based on its yield status and thus selects process 112B. Control server responds to process 112B with a proceed response 150B, causing process 112B to unblock.

In some embodiments, process 112B may interact with process 112A to facilitate the previously requested operation. For example, process 112B may respond to process' 112A read request by fetching the required data. After receiving a response to its network call, process 112A transitions from the yield state to a blocked state and its status information 130 is updated. Process 112B executes until it reaches breakpoint 382 and performs a breakpoint call 322B, causing process 112B to block. Control server 120 continues to make scheduling decisions to schedule process 112A and 112B based on their respective scheduled time 250A and 250B.

Control server instantiates process 112C, and after starting up, process 112C performs register call 320C to register with control server 120. Again, control server 120 increments the logical clock to the next minimum scheduled time 250 and selects a process 112 from a list of available processes 112 registered with controls server 120. Control server 120 continues to make scheduling decisions to execute process 112A-C serially until all process 112 have terminated and deregistered from control server at deregister block 376, 384. 396 via exit call 324A-C, respectively.

Turning now to FIG. 4A, a block diagram of a breakpoint database 430 receiving breakpoint records 440 is shown. In the illustrated embodiment, breakpoint database 430 receives breakpoint records 440 from process 112A and process 112B. As further depicted, process 112A includes breakpoints 410 and 414 and a fork block 412, and process 112B includes breakpoints 420 and 422. In some embodiments, breakpoint database 430 is implemented differently than shown. For example, breakpoint database 430 may receive information (e.g., records) pertaining to the termination of a process.

Breakpoint database 430, in various embodiments, is a collection of breakpoint records stored in a storage repository. As previously discussed, a breakpoint record is information (e.g., record) that includes a timestamp describing when a process 112 reached a particular breakpoint. In various embodiments, the stored breakpoint records are used to determine the respective execution paths of one or more processes 112 executing in a production environment or another environment, such as a sandbox. In some embodiments, the information includes the identity of the executing process 112, the breakpoint position within the code, and a timestamp indicating the time at which the process 112 reached the breakpoint. Based on that information included in the breakpoint records, the control server 120 may determine a schedule ordering of the processes 112 when replaying their execution paths. For example, based on multiple breakpoint records, control server 120 may determine that process 112A reached its first breakpoint prior to process 112B reaching its first breakpoint. As shown, process 112A reaches breakpoint 410 and provides a breakpoint record 440A to breakpoint database 430. Process 112A continues to execute and fork at fork block 412, producing a child process 112B. In some embodiments, process 112B may produce a start-up record and provide it to breakpoint database 430. Process 112A and process 112B continue to execute concurrently while producing a breakpoint record at breakpoint 414 and breakpoint records at breakpoint 420 and 422, respectively.

Control server 120 retrieves the collection of breakpoint records from breakpoint database 430 to perform a replay operation. A replay is a deterministic re-execution of processes 112 based on the collection of breakpoint records to facilitate the debugging of the production environment. When a software bug is discovered during production, control server 120 can deterministically schedule the processes 112 in the same ordering so that developers can determine the cause of the bug. By scheduling the processes 112 to execute serially using breakpoints, developers can perform a step-by-step analysis of the production environment. For example, node 110A may crash due to poorly written code, and as a result, part of the database may come to a halt as other nodes 110 try to communicate with node 110A. By replaying the same ordering of events, developers can analyze each step during the production operation to determine that node 110A crashed at a particular timestamp and breakpoint position. An example of control server 120 replaying the ordering of processes is discussed with respect to FIG. 4B.

Turning now to FIG. 4B, a block diagram of control server 120 performing a scheduling operation for process 112A and process 112B based on the collection of breakpoint records generated in the production environment depicted in FIG. 4A. As further depicted, process 112A includes a breakpoint 410, a fork block 412, and a breakpoint 414, and process 112B includes breakpoints 420 and 422. In some embodiments, the scheduling process performed by control server 120 is implemented differently than shown. For example, control server 120 may schedule a plurality of processes 112 to reproduce the production environment.

Control server 120 retrieves the collection of breakpoint records from breakpoint database 430 to perform a replay operation. Control server 120 replays the execution paths for process 112A and process 112B based on the collection of breakpoint records. As previously discussed, when process 112A starts up, it registers to control server 120, and module 215 assigns status information 130 to process 112A. Status information 130, such as process ID 230, may be derived from the information within a breakpoint record. For example, control server 120 may determine a scheduled time 250A for process 112A based on the timestamp recorded in a breakpoint record.

As previously discussed, process 112A executes until it reaches breakpoint 410 and performs a breakpoint call 322A to control server 120. Control server 120 makes a scheduling decision and selects the next process 112 based on the execution paths determined by the breakpoint records. In some embodiments, control server 120 may wait for user input prior to unblocking the next scheduled process. For example, a developer may analyze the state of the production environment at each blocking call before notifying control server 120 to proceed. After receiving the proceed response, process 112A continues to execute and reaches fork block 412 where it performs a forking operation 350 to create process 112B. Control server 120 continues to schedule process 112A and process 112B at breakpoint 414 and breakpoints 420 and 422, respectively, based on the collection of breakpoint records until processes 112A and 112B have terminated. In other embodiments, control server 120 may schedule processes 112 until it encounters the bug observed during the production environment.

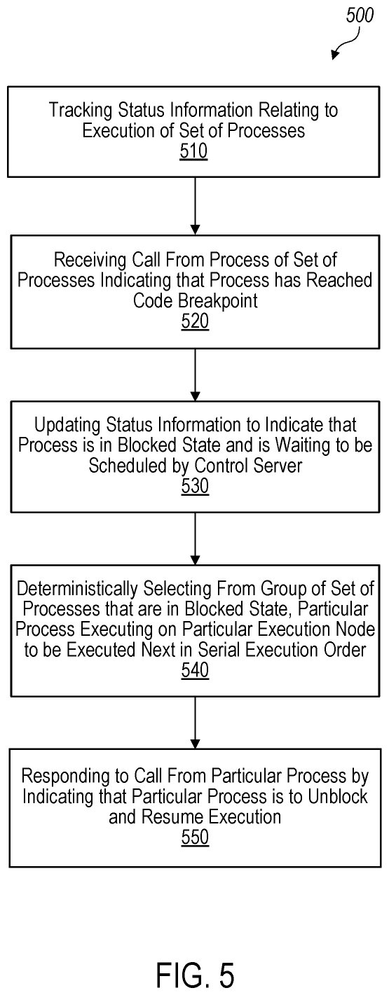

Turning now to FIG. 5, a flow diagram of a method 500 is shown. Method 500 is one embodiment of a method performed by a control server (e.g., control server 120) that is executing on a computer system for controlling ordering of a set of processes (e.g., process 112A-N) executing on different execution nodes (e.g., node 110A-N) of a computer system. Method 500 may be performed by executing program instructions stored on a non-transitory computer-readable medium. Method 500 may include more or less steps than shown. For example, there may be a step in which the control server receives an input value (e.g., seed) to deterministically select a particular process (e.g., process 112).

Method 500 begins in step 510 with the control server tracking status information (e.g., status information 130) relating to execution of the set of processes. In some embodiments, the control server receives, from a parent process within the set of processes, an indication (e.g., fork call 326) that a child process has been created (e.g., fork block 342). The control server registers the child process and adds the registered child processes to the set of processes to be scheduled for execution. If the execution of the set of processes is part of a simulation, control server, in various embodiments, maintains a logical clock (e.g., time module 225) having a current time value that can be provided to the set of processes, and the group of the set of processes are those processes that are eligible to be scheduled at the current time value of the logical clock. In response to no processes being eligible to be executed at the current time value of the logical clock, control server advances the logical clock to a next time value that is associated with eligible processes.

In step 520, the control server receives a call from a process (e.g., breakpoint call 322) of the set of processes indicating that the process has reached a code breakpoint (e.g., breakpoint 312). In various embodiments, control server receives, from a first process of the set of processes, a request to enter a yield state (e.g., yield state 246) that indicates that the first process is waiting on a condition to be fulfilled prior to entering the blocked state (e.g., blocked state 244). In response to the request, control server may place the first process in the yield state. While the first process is in the yield state, control server receives an update from the first process indicating that the condition has been fulfilled. In some embodiments, the condition is fulfilled upon the first process receiving data as a result of a request issued by the first process to a second process of the set of processes that is executing on a different execution node. In response to the update, control server places the first process in the blocked state.

In step 530, the control server updates the status information (e.g., status information 130) to indicate that the process is in a blocked state and is waiting to be scheduled by the control server. The status information further may include an identity (e.g., process ID 230) of the given process, a current state (e.g., process status 240) assigned to the given process, and a minimum scheduled time (e.g., scheduled time 250) that indicates a next time value of a logical clock maintained by the control server that the given process is available for scheduling.

In step 540, the control server deterministically selects (e.g., scheduling module 220), from a group of the set of processes that are in the blocked state, a particular process executing on a particular execution node to be executed next in a serial execution order. In some embodiments, the control server randomly selects the particular process using an input seed value (e.g., seed 305) that is stored for later use. In some embodiments, the control server replays the execution of the set of processes using the input seed value to recreate the serial execution order. Method 500 may be performed as part of executing the set of processes in order to implement a software application in a production environment. The control server stores (e.g., breakpoint database 430) timing information (e.g., breakpoint record 440) that is usable to specify that the process has reached a particular code breakpoint at a particular time value of a system clock for the production environment. In some embodiments, the timing information is usable in subsequently replaying the execution of the set of processes to recreate the serial execution order.

In step 550, the control server responds to a call (e.g., proceed response 150) from the particular process by indicating that the particular process is to unblock and resume execution. If the execution of the set of processes is part of a simulation, the call from the process, indicating that the process has reached a code breakpoint, includes the minimum scheduled time (e.g., scheduled time 250) that when, according to the logical clock, the process can next be scheduled.

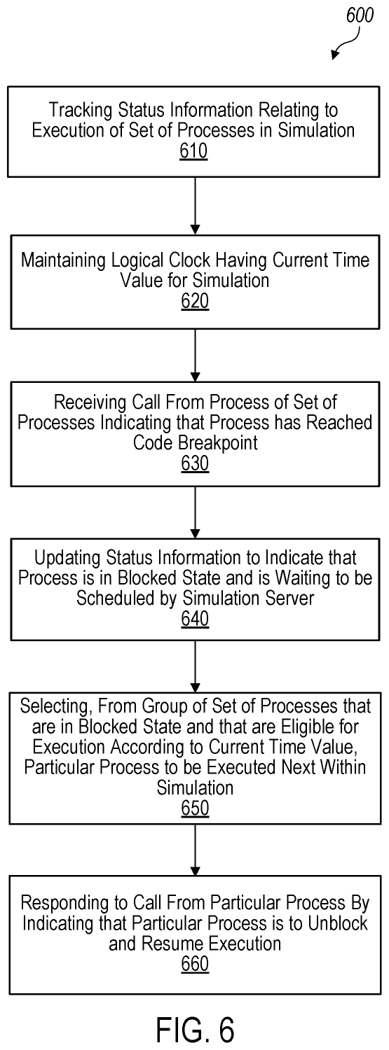

Turning now to FIG. 6, a flow diagram of a method 600 is shown. Method 600 is one embodiment of a method performed by a control server (e.g., control server 120) that is executing on a computer system implementing a simulation server. Method 600 may be performed by executing program instructions stored on a non-transitory computer-readable medium. Method 600 may include more or less steps than shown. For example, there may be a step in which the control server receives an input value (e.g., seed 305) to deterministically select a particular process (e.g., process 112).

Method 600 begins in step 610 with the computer system tracking status information (e.g., status information 130) relating to execution of a set of processes (e.g., processes 112A-N) in a simulation. The computer system receives, from a first process of the set of processes, a request to enter a yield state (e.g., yield state 246) that indicates that the first process is waiting on a condition to be fulfilled prior to entering the blocked state. In response to the request, the computer system places the first process in the yield state. While the first process is in the yield state, the computer system receives an update from the first process indicating that the condition has been fulfilled. In response to the update, the computer system places the first process in the blocked state (e.g., blocked state 244).

In step 620, the computer system maintains a logical clock (e.g., time module 225) having a current time value for the simulation. In response to no processes being eligible to be executed at the current time value of the logical clock, the computer system advances the logical clock to a next time value that is associated with eligible processes.

In step 630, the computer system receives a call (e.g., breakpoint call 322) from a process of the set of processes indicating that the process has reached a code breakpoint (e.g., breakpoint 312). In some embodiments, the call from the process, indicating that the process has reached a code breakpoint, includes a minimum scheduled time (e.g., scheduled time 250) that when, according to the logical clock, the process can next be scheduled. In step 640, the computer system updates the status information to indicate that the process is in a blocked state (e.g., process status 240) and is waiting to be scheduled by the simulation server.

In step 650, the computer system selects, from a group of the set of processes that are in the blocked state and that are eligible for execution according to the current time value, a particular process to be executed next within the simulation. In some embodiments, the selecting is performed in a manner that permits a current serial execution order of the set of processes to be recreated. In step 660, the computer system responds to a call (e.g., proceed response 150) from the particular process by indicating that the particular process is to unblock and resume execution.

Various techniques described herein may be performed by one or more computer programs. For example, computer programs for implementing functionality of a node 110, a process 112, and/or control server 120. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems (e.g., computer systems that implement nodes 110A-N) in which the programs are executed, as well as in a second set of one or more computer systems (e.g., a computer system that implements control server 120) which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. For example, a node 110 may not execute instructions to interact with control server 120 during a production mode (as opposed to a testing mode); however, the instructions may be resident on the computer system of that node 110. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

Similarly, systems that implement the methods described with respect to any of the disclosed techniques are also contemplated. One such environment in which the disclosed techniques may operate is a cloud computer system. For example, nodes 110A-N and control server 120 may be part of a distributed database architecture that is implemented by a cloud computer system. A cloud computer system (or cloud computing system) refers to a computer system that provides on-demand availability of computer system resources without direct management by a user. These resources can include servers (e.g., control server 120), storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. For example, nodes 110A-N may be located in different computing zones. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. The techniques discussed above may be implemented in a data center—e.g., nodes 110A-N and control sever 120 may be implemented by computer systems spread across the data center. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together to provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method for controlling ordering of a set of processes executing on different execution nodes of a computer system, the method comprising:
tracking, at a control server, status information relating to execution of the set of processes;
receiving, at the control server, a call from a process of the set of processes indicating that the process has reached a code breakpoint;
updating, by the control server, the status information to indicate that the process is in a blocked state and is waiting to be scheduled by the control server;
deterministically selecting, by the control server from a group of the set of processes that are in the blocked state, a particular process executing on a particular execution node to be executed next in a serial execution order; and
responding, by the control server, to a call from the particular process by indicating that the particular process is to unblock and resume execution.

2. The method of claim 1, wherein the status information further includes, for a given process of the set of processes:
an identity of the given process;
a current state assigned to the given process; and
a minimum scheduled time that indicates a next time value of a logical clock maintained by the control server that the given process is available for scheduling.

3. The method of claim 1, wherein tracking and updating the status information includes:
receiving, from a first process of the set of processes, a request to enter a yield state that indicates that the first process is waiting on a condition to be fulfilled prior to entering the blocked state;
in response to the request, placing the first process in the yield state;
while the first process is in the yield state, receiving an update from the first process indicating that the condition has been fulfilled; and
in response to the update, placing the first process in the blocked state.

4. The method of claim 3, wherein the condition is fulfilled upon the first process receiving data as a result of a request issued by the first process to a second process of the set of processes that is executing on a different execution node.

5. The method of claim 1, wherein the tracking includes:
receiving, from a parent process within the set of processes, an indication that a child process has been created; and
registering the child process and adding the registered child processes to the set of processes to be scheduled for execution.

6. The method of claim 1, wherein deterministically selecting includes randomly selecting the particular process using an input seed value that is stored for later use.

7. The method of claim 6, further comprising:
replaying the execution of the set of processes using the input seed value to recreate the serial execution order.

8. The method of claim 1, wherein the execution of the set of processes is part of a simulation, the method further comprising:
maintaining, by the control server, a logical clock having a current time value that can be provided to the set of processes; and
wherein the group of the set of processes are those processes that are eligible to be scheduled at the current time value of the logical clock.

9. The method of claim 8, wherein the call from the process indicating that the process has reached a code breakpoint includes the minimum scheduled time that when, according to the logical clock, the process can next be scheduled.

10. The method of claim 8, further comprising:
in response to no processes being eligible to be executed at the current time value of the logical clock, advancing the logical clock to a next time value that is associated with eligible processes.

11. The method of claim 1, wherein the method is performed as part of executing the set of processes in order to implement a software application in a production environment, and wherein the method further comprising storing timing information that is usable to specify that the process has reached a particular code breakpoint at a particular time value of a system clock for the production environment; and
wherein the timing information is usable in subsequently replaying the execution of the set of processes to recreate the serial execution order.

12. A non-transitory computer-readable medium having program instructions stored thereon that are capable of causing a computer system to implement a control server that performs operations comprising:
receiving an indication that a given process of a set of processes to be executed has reached a code breakpoint;
updating status information to indicate that the given process is in a blocked state and is waiting to be scheduled by the control server for further execution;
deterministically selecting, from a group of the set of processes that are in the blocked state, a particular process to be executed next; and
responding to a call from the particular process by indicating that the particular process is to resume execution.

13. The non-transitory computer-readable medium of claim 12, wherein updating the status information includes:
receiving, from a first process of the set of processes, a request to enter a yield state that indicates that the first process is waiting on a condition to be fulfilled prior to entering the blocked state; and
in response to the request, placing the first process in the yield state.

14. The non-transitory computer-readable medium of claim 12, wherein updating the status information includes:
in response to a registration request from a particular process, registering the particular process to the status information, causing the registered particular process to be added to the set of processes; and
in response to a termination request from the particular process, deregistering the particular process from the status information, causing the deregistered particular process to be removed from the set of processes.

15. The non-transitory computer-readable medium of claim 12, wherein receiving an indication includes:
storing timing information that is usable to specify that the particular process has reached a particular code breakpoint at a particular time value of a system clock for a production environment; and
wherein the timing information is usable in subsequently replaying the execution of the set of processes to recreate a serial execution order.

16. The non-transitory computer-readable medium of claim 12, wherein deterministically selecting includes randomly selecting the particular process using an input seed value that is stored for later use.

17. A non-transitory computer-readable medium having program instructions stored thereon that are capable of causing a computer system to implement a simulation server that performs operations comprising:
tracking status information relating to execution of a set of processes in a simulation;
maintaining a logical clock having a current time value for the simulation;
receiving a call from a process of the set of processes indicating that the process has reached a code breakpoint;
updating the status information to indicate that the process is in a blocked state and is waiting to be scheduled by the simulation server;
selecting, from a group of the set of processes that are in the blocked state and that are eligible for execution according to the current time value, a particular process to be executed next within the simulation, wherein the selecting is performed in a manner that permits a current serial execution order of the set of processes to be recreated; and
responding to a call from the particular process by indicating that the particular process is to unblock and resume execution.

18. The non-transitory computer-readable medium of claim 17, wherein tracking and updating the status information includes:
receiving, from a first process of the set of processes, a request to enter a yield state that indicates that the first process is waiting on a condition to be fulfilled prior to entering the blocked state;
in response to the request, placing the first process in the yield state;
while the first process is in the yield state, receiving an update from the first process indicating that the condition has been fulfilled; and
in response to the update, placing the first process in the blocked state.

19. The non-transitory computer-readable medium of claim 17, wherein the call from the process indicating that the process has reached a code breakpoint includes a minimum scheduled time that when, according to the logical clock, the process can next be scheduled.

20. The non-transitory computer-readable medium of claim 19, wherein maintaining the logical clock further includes:
in response to no processes being eligible to be executed at the current time value of the logical clock, advancing the logical clock to a next time value that is associated with eligible processes.
